(19) United States
(12) Patent Application Publication
(10) Pub. No.: US 2006/0091869 A1
(43) Pub. Date: May 4, 2006

(54) Method of and system for regulating a power supply

(75) Inventor: Xiaoyong Zhang, San Jose, CA (US)

Correspondence Address: MCDERMOTT WILL & EMERY LLP, 600 13TH STREET, N.W., WASHINGTON, DC, 20005-3096, US

(73) Assignee: LINEAR TECHNOLOGY CORPORATION

(21) Appl. No.: 10/976,871

(22) Filed: Nov. 1, 2004

(51) Int. Cl. G05F 1/40

(52) U.S. Cl. 323/282

(57) ABSTRACT

A method of and system for regulating a power supply includes measuring an inductor ripple current within the power supply, and producing an active voltage positioning offset voltage for compensating an output voltage. The active voltage positioning offset voltage is based in part on the measured inductor ripple current.

### TECHNICAL FIELD

This disclosure relates to regulating power supplies and, more particularly, to regulating power supplies with active voltage positioning.

### BACKGROUND

Changing load conditions affect power supply performance, especially when supplies try to meet the low voltage, high current demands of microprocessors or other types of integrated circuitry. Microprocessors frequently can change their load current requirements from a no load condition to a maximum load current condition (and back again) very quickly. The rising and falling edges of these load current transitions, which are known as load steps, can exceed operational bandwidth as the power supply tries to maintain the proper output voltage and current. For example, typical load steps may include transitions from 0.2 ampere (A) to 12.0 A in 100 nanoseconds (ns), or from 12.0 A to 0.2 A in the same time period while the voltage provided by the power supply needs to be held roughly within ±0.1 volt of its nominal voltage.

In an attempt to minimize voltage deviation during a load step, a technique known as Active Voltage Positioning (AVP) has been developed that controls the output impedance of a power supply. In general, AVP attempts to set the power supply output voltage at a particular level based upon the load current. Usually, as load current increases, the output voltage proportionally decreases. To compensate for these variations using AVP, at minimum load, the output voltage is set to be slightly higher than a nominal voltage level; and at full load, the output voltage is set to be slightly lower than the nominal voltage level. By setting the output voltage slightly higher or lower, transient load voltage deviation is significantly improved. Additionally, by incorporating AVP into power supply designs, layout space and costs are conserved by reducing the required number of output capacitors.

To set the output voltage slightly higher or lower than the nominal level, conventional AVP techniques monitor the maximum or minimum load current provided by the power supply. When using either of these constant load current values, load current variations are ignored and errors may be introduced into the AVP. In particular, under a light load condition, if large load currents are experienced, errors can be introduced.

### SUMMARY OF THE DISCLOSURE

In accordance with an aspect of the disclosure, a method of regulating a power supply includes measuring an inductor ripple current within the power supply, and producing an active voltage positioning offset voltage for compensating an output voltage. The active voltage positioning offset voltage is based in part on the measured inductor ripple current.

In a preferred embodiment, the method may further include adjusting the output voltage in accordance with the active voltage positioning offset voltage. The output voltage may also be adjusted based on other quantities, such as the sum of the active voltage positioning offset voltage and the output voltage. In some embodiments the inductor ripple current may be determined by measuring current propagating in an inductor current sense resistor or by another current sensing technique.

In accordance with another aspect, a system for implementing the methodology may include a current sensor for measuring an inductor ripple current within a power supply, and a voltage source for producing an active voltage positioning offset voltage for compensating an output voltage. The active voltage positioning offset voltage is based in part on the measured inductor ripple current.

In one embodiment of the system, the current sensor may be an inductor current sense resistor. Based in part on the measured inductor ripple current, the supply output may be regulated by monitoring the sum of the output voltage and the active voltage positioning offset voltage. While an absolute voltage level can be used to produce the active voltage positioning offset voltage, in some embodiments, scaled voltages may be used produce the offset voltage. Real-time and buffered voltages may be used to produce the offset voltage.

In accordance with another aspect of the disclosure, a voltage regulator for regulating a power supply may include an inductor current sense resistor for sensing an inductor ripple current. The voltage regulator may also include a voltage amplifier for receiving a voltage drop across the inductor current sense resistor and for producing an active voltage positioning offset voltage. Additional circuitry in the regulator may substantially hold the sum of the active voltage positioning offset voltage and an output voltage at a constant value.

In one embodiment, the voltage regulator may include circuitry for measuring the difference between the constant value and the sum of the active voltage positioning offset voltage and the output voltage.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

FIG. 1 is a block diagram depicting portions of a conventional computer system.

FIG. 2 is a block diagram depicting a conventional power supply that may be used to provide power to the computer system.

FIG. 3 is a circuit diagram of a power supply regulator that implements conventional AVP to regulate the output of the power supply.

FIG. 4 is a block diagram depicting a power supply that provides a compensated output in accordance with the disclosure.

FIG. 5 is a block diagram of a power supply regulator that monitors inductor current for AVP to compensate the power supply output.

FIG. 6 is one embodiment of a power supply regulator circuit that implements AVP and monitors inductor current.

### DETAILED DESCRIPTION OF THE PREFERRED EMBODIMENTS

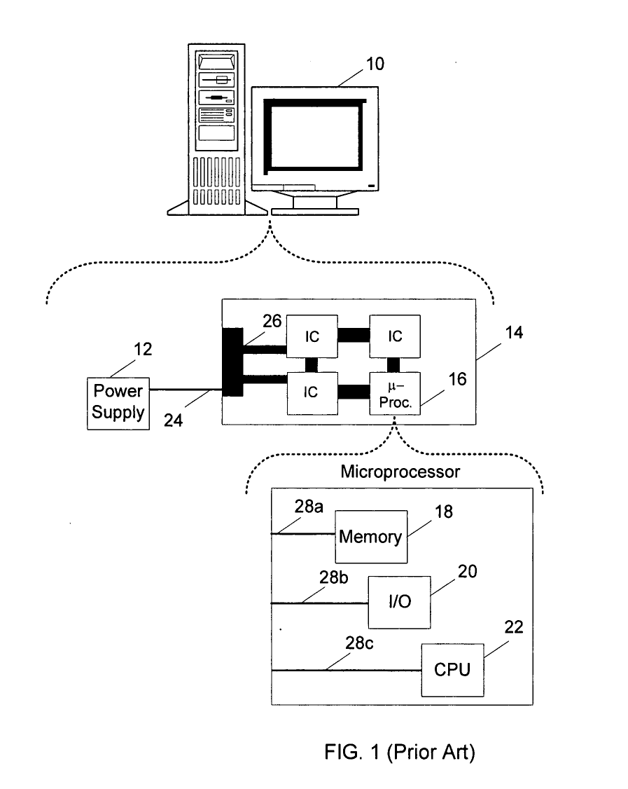

Referring to FIG. 1, a computer system 10 includes a power supply 12 that provides power to a computer card 14 that is populated with numerous integrated circuit (IC) chips. One of the IC chips, a microprocessor 16, includes components such as a memory unit 18, an Input/Output (1/O) unit 20, and a central processing unit (CPU) 22, all of which receive power from power supply 12. An off-board conductor 24 and a series of on-board conductive traces 26 transmit power from power supply 12 to microprocessor 16. On-chip conductive traces 28a-c provide power to each appropriate portion of microprocessor 16. Incorporating AVP into power supply 12 can assist in regulating the output voltage provided to each portion of microprocessor 16 and to other loads in computer system 10.

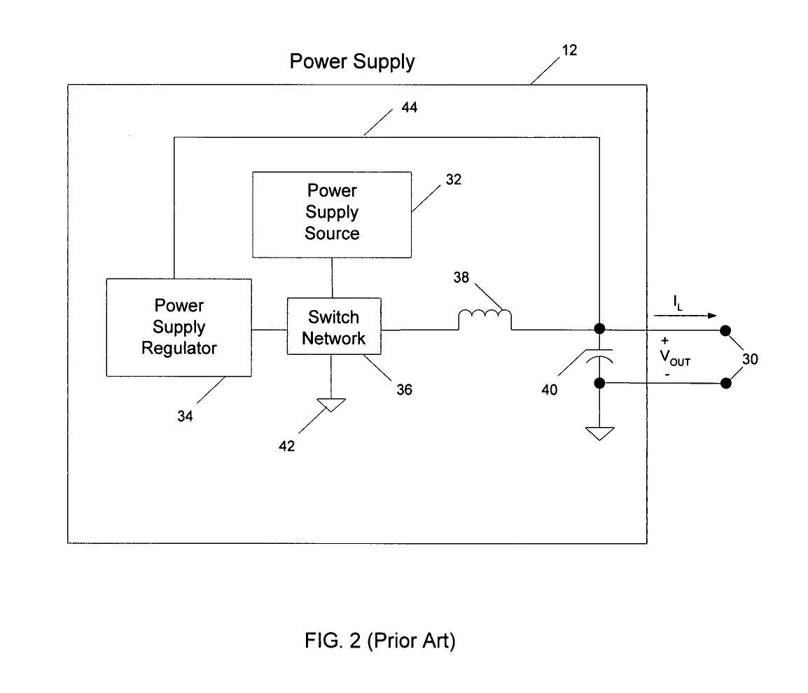

Referring to FIG. 2, power supply 12 includes a pair of output terminals 30 at which an output voltage V_{OUT} is accessible for providing power to the units of microprocessor 16. Power supply 12 also includes a power supply source 32, such as a voltage source, which is used to produce V_{OUT}. To regulate the level of V_{OUT}, a power supply regulator 34 controls the duty cycles of switches included in a switch network 36. In one instance, regulator 34 can increase the duty cycle of switch network 36 to increase the connection duration time between power supply source 32 and an output capacitor 40 (through an inductor 38) that is maintaining V_{OUT} at output terminals 30. By increasing the connection duration time current more readily flows from power supply source 32 to output capacitor 40 and V_{OUT} increases. In another instance, regulator 34 can decrease the duty cycle of switch 36 to decrease the connection duration time between power supply source 32 and inductor 38. Furthermore, the connection duration time may also be adjusted between inductor 38 and a ground terminal 42 to regulate V_{OUT}. Thus, by controlling the duty cycle of the switches included in network switch 36, power supply regulator 34 attempts to maintain V_{OUT} as load conditions change.

To determine the duty cycles of switch network 36, V_{OUT} is monitored by power supply regulator 34. A conductor 44 feeds back V_{OUT} from output capacitor 40 to regulator 34. If V_{OUT} falls below a defined level, power supply regulator 34 signals switch network 36 to adjust the duty cycle of the switch between power supply source 32 and inductor 38 such that V_{OUT} increases. Similarly when V_{OUT} reaches a required level, power supply regulator 34 signals switch network 36 to balance the duty cycles of the switches to maintain V_{OUT}.

With output terminals 30 connected to a load, load current I_{L} flows from output capacitor 40 to the load. Typically, an increase in current load I_{L} can cause reductions in V_{OUT}. For example, if a load step occurs, I_{L} increases and the level of V_{OUT} correspondingly decreases. Conductor 44 provides this reduction in V_{OUT} to regulator 34 so that control switch network 36 adjusts V_{OUT} toward a target value based on AVP.

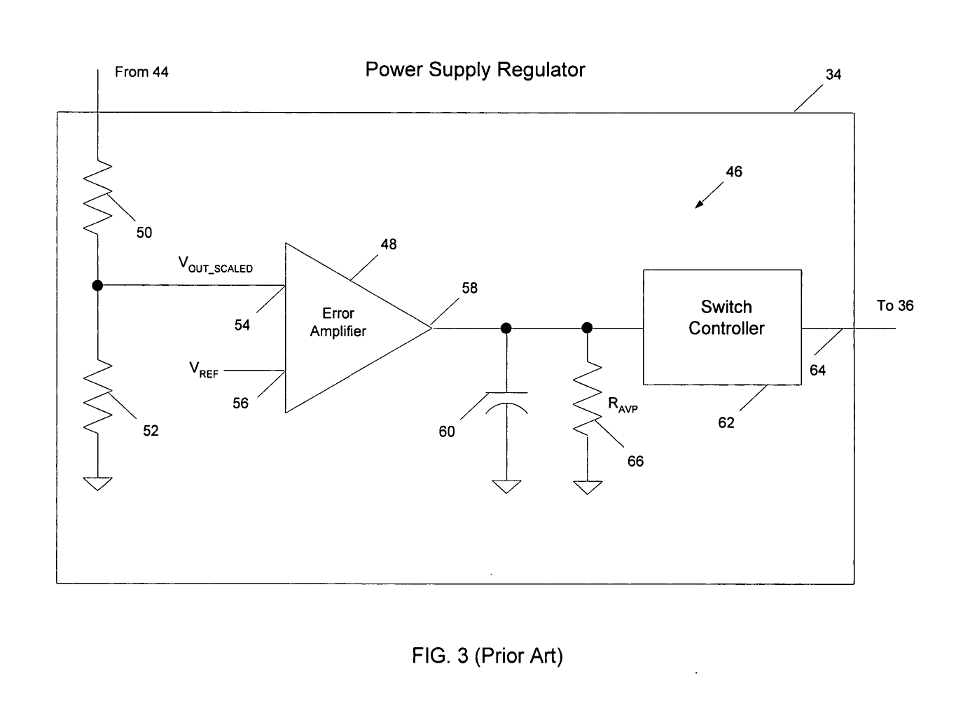

Referring to FIG. 3, power supply regulator 34 implements AVP in a power supply control loop 46 such that the output impedance of an error amplifier 48 is set to regulate V_{OUT}. Resistors 50 and 52 form a voltage divider that produce a scaled version (V_{OUT}_{_{—}}_{SCALED}) of V_{OUT} that is provided by conductor 44. V_{OUT}_{_{—}}_{SCALED} is provided by the voltage divider to input 54 of error amplifier 48. Error amplifier 48 determines the difference between V_{OUT}_{_{—}}_{SCALED} and a reference voltage V_{REF} that is present at an input 56. Typically, V_{REF} is the desired set point for V_{OUT} (e.g., the power supply output voltage under a no load condition).

If V_{OUT}_{_{—}}_{SCALED} is not equal to V_{REF}, a current indicative of the absolute voltage difference flows from output 58 of error amplifier 48 to capacitor 60. In general, if V_{REF} is larger than V_{OUT}_{_{—}}_{SCALED} current flows out of output 58 and the voltage across capacitor increases. Correspondingly, if V_{REF} is less than V_{OUT}_{_{—}}_{SCALED} current flows (“sinks”) into output 58 and the voltage across capacitor decreases. The voltage across capacitor 60 is detected at a switch controller 62 included in power regulator 34. Due to the detected voltage change, switch controller 62 sends a control signal over a conductor 64 to switch network 36. The control signal initiates duty cycle adjustments in switch network 36 such that V_{OUT} increases to compensate for the increase in I_{L}. When V_{OUT} reaches a level such that V_{OUT}_{_{—}}_{SCALED} is equal to V_{REF}, current flow at output 58 essentially stops and the level of the voltage across capacitor 60 remains stable. Sensing the voltage on capacitor 60, switch controller 62 signals switch network 36 to balance the duty cycle of switch network 36.

To provide AVP, resistors (e.g., an equivalent resistance R_{AVP} 66) are connected across capacitor 60. The resistance of R_{AVP} 66 causes V_{OUT} to be set slightly higher for low load currents and slightly lower for large load currents. For example, if V_{REF} is slightly larger than V_{OUT}_{_{—}}_{SCALED}, a small current flows at output 58. Since R_{AVP} 66 is in parallel with capacitor 60, this small current flows through R_{AVP} rather than capacitor 60. The voltage across capacitor 60 remains substantially constant and switch controller 62 adjusts the duty cycle of switch network 36 to a target value according to AVP. Thus, V_{OUT} is held slightly lower in accordance with AVP as I_{L} increases. However, if the load current continues to increase, only a portion of the current flows through R_{AVP} 66 and the remaining current causes the voltage across capacitor 60 to increase. Sensing this voltage increase, switch controller 62 sends a signal to switch network 36 to initiate a duty cycle adjustment. Thus, the resistance of R_{AVP} 66 sets the boundaries to which V_{OUT} is adjusted due to variations in the load current in accordance with AVP.

Since the maximum or minimum current that flows through inductor 38 is used in the AVP, variations of the current that flows through inductor 38 are ignored when applying AVP to the power supply output. These current variations, known as inductor ripple current, can vary with input voltage, output voltage, switching frequency, etc., and are not represented in the voltage across capacitor 60. Since inductor ripple current can be a significant factor in the total load current (especially in light load conditions), ignoring the inductor ripple current may introduce significant error into the active voltage positioning.

Furthermore, error amplifier 48 is typically a transconductance amplifier (i.e., an amplifier that converts a voltage level into a current level), whose transconductance factor (gm) may vary with temperature and production variants. In order to reduce the effects of these variations, additional circuitry may be included in error amplifier 48. However, such circuitry increases cost and degrades the speed of control loop 46, which in turn degrades the performance of the entire power supply.

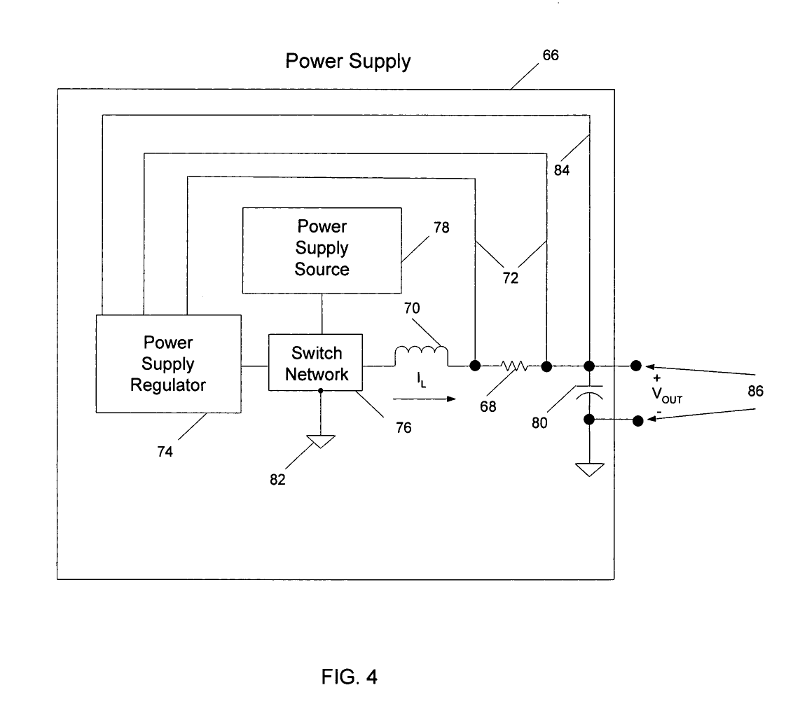

Referring to FIG. 4, by accounting for inductor ripple current in AVP, the output voltage V_{OUT} of a power supply 66 is less susceptible to voltage variations due to load steps. Additionally, by reducing variations in V_{OUT}, power supply stability increases along with accuracy and controllability. In this arrangement, power supply 66 includes an inductor current sense resistor 68 that is used to determine the ripple current propagating through an inductor 70. In particular, a pair of conductors 72 is connected across resistor 68 for feeding the voltage across the resistor back to a power supply regulator 74. By feeding back this voltage, the load current I_{L} (which includes inductor ripple current component) can be determined, and power supply regulator 74 more effectively regulates the output V_{OUT} for variations in the load current.

While inductor current sense resistor 68 is used in this arrangement to provide I_{L} to power supply regulator 74, in some arrangements other current sensing techniques may be used individually or in combination to provide I_{L}. For example, a voltage drop may be measured across a power switch such as switch included a switch network 76 that controls current flow from a power supply source 78 through inductor 70 and to an output capacitor 80. While such a voltage drop is stable, temperature and production variants may introduce error into the voltage measurement. One or more resistors may also be placed in series with a switch included in switch network 76 for measuring a voltage drop. The load current including the ripple current may also be sensed with a magnetic transducer (e.g., an inductor), or by another technique that directly or indirectly provides I_{L} from a current sensor. In some arrangements an average ripple current is used by power regulator 74 in AVP. For example, an average ripple current may be determined by power supply regulator 74 from the voltage across inductor current sense resistor 68 that is provided by conductor pair 72. Additional components may also be connected to inductor current sense resistor 68 to determine an average ripple current. For example, a capacitor serially connected to a resistor may be connected in parallel across inductor current sense resistor 68 to provide an average voltage to power supply regulator 74 via conductor pair 72.

Similar to power supply 12 shown in FIG. 2, power supply regulator 74 controls switches within switch network 76 to regulate the flow of current to output capacitor 80 by controlling the connection between inductor 70 and power supply source 78, and the connection between inductor 70 and a ground terminal 82. Such use and control of a switch network is described in “An Innovative Digital Control Architecture for Low-Voltage, High Current DC-DC Converters with tight Voltage Regulation,” IEEE Transactions on Power Electronics, Vol. 19, No. 1, January 2004, which is herein incorporated by reference. Also similar to power supply 12, a conductor 84 connects to output capacitor 80 to feedback (to power supply regulator 74) the level of V_{OUT} delivered at a pair of output terminals 86.

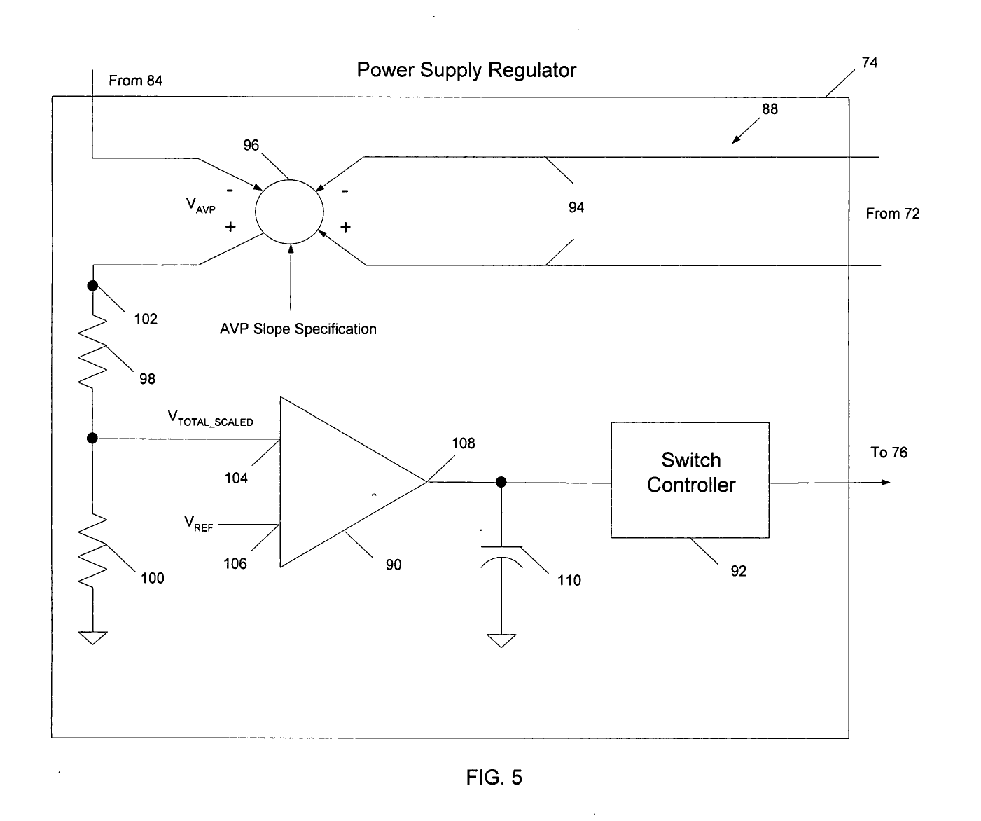

Referring to FIG. 5, a block diagram of power supply regulator 74 includes a control loop 88 that uses the measured load current and inductor ripple current with AVP to regulate the output voltage V_{OUT}. AVP is described in “Active Voltage Positioning Saves Output Capacitors in Portable Computer Applications”, Linear Technology Magazine, February 2000, and “Active Voltage Positioning Reduces Output Capacitors”, Linear Technology Design Notes, Design Note 224, both of which are herein incorporated by reference.

Similar to control loop 46 shown in FIG. 3, an error amplifier 90 along with a switch controller 92 is included in control loop 88 to regulate V_{OUT}. A pair of conductors 94 is connected to conductors 72 (shown in FIG. 4) that provide the voltage drop across inductor current sense resistor 68. Since the resistance of sense resistor 68 is known, by measuring the voltage drop across the sense resistor, the load current I_{L} (including inductor ripple current) that propagates through inductor 70 may be determined. For example, a load current may have an average value of 10.0 A and a ripple current that may be represented as a saw-tooth waveform with a maximum value of 11.0 A and a minimum value of 9.0 A.

To implement AVP such that V_{OUT} is set slightly above or below a nominal value, dependent upon the load condition, an offset voltage V_{AVP} is produced from the load current I_{L} including the inductor ripple component. The offset voltage V_{AVP} is applied to the output voltage V_{OUT}, which is provided by conductor 84, to control compensating of V_{OUT} in accordance with AVP.

To provide the offset voltage V_{AVP}, control loop 88 includes a controllable voltage source 96 that receives the voltage drop at inductor current sense resistor 68. Conductor pair 94 directly provides the voltage drop to the controllable voltage source 96. However, in some arrangements, the voltage may be buffered or processed (e.g., filtered) prior to receiving at controllable voltage source 96.

To determine V_{AVP} from the load current I_{L}, a preset AVP slope specification is used to convert the current level to an appropriate V_{AVP}. The AVP slope can be represented as a gain factor K that multiples with the load current to produce V_{AVP}:
V_{AVP}=K*I_{L}. (1)

As an example, an AVP slope of 1-2 millivolts/A can be used to set V_{AVP} for 1-2 millivolts or each ampere that I_{L} increases. Along with determining V_{AVP} for the average value of I_{L}, since the inductor ripple current is represented in I_{L}, V_{AVP} accounts for current variants due to the ripple. For example, as I_{L} varies between 9.0 A to 11.0 A in a saw-tooth fashion, V_{AVP} produced by controllable voltage source 96 tracks these variations so that AVP accounts for the ripple current.

Typically, the AVP slope specification is dependent upon the particular AVP circuitry implemented, and the application of the power supply. In some arrangements, the value of the AVP slope specification is set by selecting particular passive components included in power supply regulator 74. By positioning the components external to regulator 74, a user can select and connect particular components (e.g., resistors) to set a desired AVP slope specification. Alternatively, for a standard AVP slope specification, preselected components such as resistors may be mounted in a non-accessible manner within regulator 74. Besides passive analog components, active components, digital circuitry or a combination of digital and analog circuitry may be incorporated for setting the AVP slope specification. Furthermore, weighting functions or values may be applied to the AVP slope specification or to I_{L} prior to producing V_{AVP}.

After the AVP offset voltage is produced to account for inductor ripple current, V_{OUT} is applied to the offset voltage. Typically V_{AVP} and V_{OUT} are summed to apply the offset voltage and control loop 88 then attempts to regulate the sum to a substantially constant value. In this implementation, V_{AVP} and V_{OUT} sum at a terminal 102 of a resistor 98. This voltage sum, which is referred to as V_{Total}, can be is represented as:
V_{Total}=V_{OUT}+V_{AVP}. (2)

Resistors 98 and 100 produce a voltage divider that scales V_{Total} to V_{TOTAL}_{_{—}}_{SCALED} and provides the scaled voltage at an input 104 of error amplifier 90. Similar to control loop 46 (shown in FIG. 3), error amplifier 90 compares a reference voltage V_{REF} (present at an input 106) to the scaled voltage V_{TOTAL}_{_{—}}_{SCALED} and, based on the comparison, a current is provided at an output 108 that represents the difference between the two voltages. If error amplifier 90 identifies a difference between V_{REF} and V_{TOTAL}_{_{—}}_{SCALED}, a current representative of the difference is provided at output 108 and a capacitor 110 stores a voltage dependent upon the current. Switch controller 92 senses the voltage across capacitor 110 and initiates a duty cycle adjustment of the switches in switch network 76 (shown in FIG. 4) so that V_{OUT} is adjusted in accordance with the AVP.

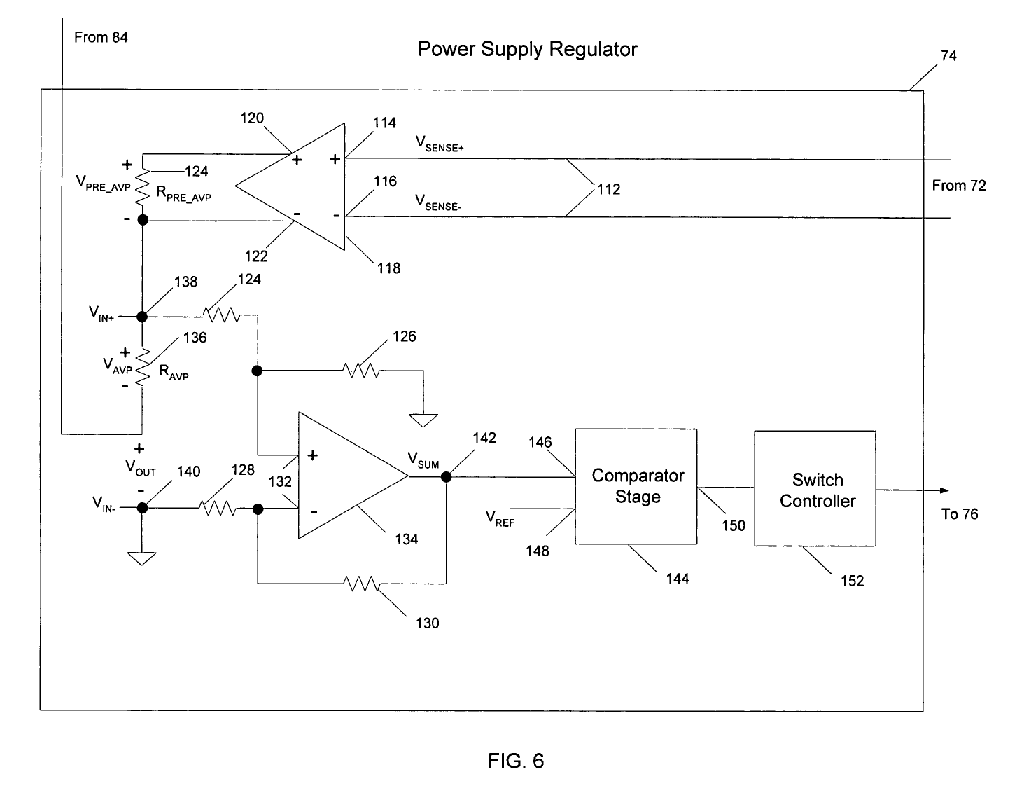

Referring to FIG. 6, one exemplary circuit of power supply regulator 74 is shown. In this particular example, regulator 74 may be implemented for inclusion in a buck DC-DC converter, an example of which is described in “Synchronously Rectified Buck—Flyback DC to DC Power Converter” (U.S. Pat. No. 5,552,695), which is herein incorporated by reference.

Similar to regulator 74 (shown in FIG. 5), a pair of conductors 112 provide the voltage drop across inductor current sense resistor 68 to respective inputs 114, 116 in a voltage amplifier 118. In this example, the voltage at input 114 is identified as V_{SENSE+} and the voltage at input 116 is identified as V_{SENSE-}. From the sensed voltage, voltage amplifier 118 provides at output terminals 120, 122 a voltage V_{PRE}_{_{—}}_{AVP} across a resistor R_{PRE}_{_{—}}_{AVP} 124. V_{PRE}_{_{—}}_{AVP} is the difference between the voltages at input terminals 114, 116 and can be represented as:
V_{PRE}_{_{—}}_{AVP}=V_{SENSE+}−V_{SENSE-} (3)

Due to high-impedance at output terminal 122, the impedance of resistors 124-130, and high-impedance at a pair of input terminals 132 of a unity-gain differential amplifier 134, a substantial portion of the current passing through resistor R_{PRE}_{_{—}}_{AVP} 124 flows to a resistor R_{AVP} 136. The current propagates through R_{AVP} 136 and produces an offset voltage V_{AVP} that is applied to the power supply output voltage V_{OUT} that is provided by conductor 84 that is connected to output capacitor 80.

Similar to regulator 74 in FIG. 5 that produces an offset voltage, V_{AVP} can be determined by multiplying the load current (represented as I_{L}) by a gain factor that represents an AVP slope specification appropriate for this application. To determine the AVP slope specification for power supply regulator 74, using a node V_{IN+} 138 and another node V_{IN-} 140, V_{AVP} can be expressed as:
V_{AVP}=V_{IN+}−V_{OUT}=V_{PRE}_{_{—}}_{AVP}*R_{AVP}/R_{PRE}_{_{—}}_{AVP} (4)

Since the voltage between V_{IN+} 138 and V_{IN-} 140 is the sum of the output voltage V_{OUT} and the offset voltage V_{AVP}, V_{AVP} can also be represented as:
V_{AVP}=V_{IN+}−V_{OUT}
=V_{PRE}_{_{—}}_{AVP}*R_{AVP}/R_{PRE}_{_{—}}_{AVP}
=[V_{SENSE+}−V_{SENSE-}]*R_{AVP}/R_{PRE}_{_{—}}_{AVP}
=I_{L}*R_{SENSE}*R_{AVP}/R_{PRE}_{_{—}}_{AVP}
=K*I_{L}. (5)

The gain factor K, which represents the AVP slope specification, is equivalent to the quantity R_{SENSE}*R_{AVP}/R_{PRE}_{_{—}}_{AVP}, where R_{SENSE} is the resistance of inductor sense resistor 68 (shown in FIG. 4) that is connected to inputs 114, 116 of voltage amplifier 118. Thus, by selecting appropriate resistance values for R_{AVP}, R_{PRE}_{_{—}}_{AVP}, and R_{SENSE}, the load current I_{L} is scaled to implement AVP with offset voltage V_{AVP}. Furthermore, since inductor ripple current is represented within I_{L}, variations in the inductor ripple current are included in the AVP.

With V_{AVP} provided across R_{AVP} 136 in accordance with AVP, the voltage between node V_{IN+} 138 and V_{IN-} 140 is present at input terminals 132 of unity-gain differential amplifier 134. With this input voltage, unity-gain differential amplifier 134 produces an output signal V_{SUM} at a node 142 equal to the voltage between these nodes 138, 140, or the sum of V_{AVP} and V_{OUT}.

V_{SUM} enters a comparator stage 144 at an input 146 and is compared to a reference voltage V_{REF} that enters at an input 148. Typically V_{REF} is the desired V_{OUT} set point that the power supply is attempting to maintain. As is known in the art, comparator stage 144 may include one or more comparators and additional circuitry for comparing the two input voltage signals V_{SUM} and V_{REF}. Based on the comparison, comparator stage 144 produces a difference signal at an output 150 that is sent to a switch controller 152 for adjusting V_{OUT}. In particular, the difference signal produced at output 150 is used by switch controller 152 to adjust the duty cycles of switches in switch network 76 (shown in FIG. 4). For example, if V_{SUM} is less than V_{REF}, comparator stage 144 may produce a difference signal at output 150 such that the switch controller 152 increases the duty cycle of a switch in switch network 76 to increase the connection frequency between power supply source 78 and inductor 70. Alternatively if V_{SUM} equals V_{REF}, comparator stage 144 may produce a zero-difference signal at output 150 such that switch controller 152 sets a duty cycle that halts further adjustments to the power supply output.

To regulate V_{OUT}, power supply regulator 74 adjusted V_{AVP} in accordance to AVP. In addition to adjusting V_{AVP} to regulate V_{OUT}, if adjusting V_{AVP} does not completely provide an appropriate V_{OUT}, further adjustments can be made to V_{OUT}. For example, the operating voltage level of power supply source 78 may be increased or decreased to respectively raise or lower V_{OUT} to a desired level.

In this implementation, one inductor current sense resistor 68 provides a voltage drop that is proportional to the load current and inductor ripple current flowing through inductor 70. However, in other implementations, two or more current sense resistors may be included for measuring multiple phases of the load current and inductor ripple current.

Also, in this particular implementation, the offset voltage V_{AVP} is not scaled prior to applying it to the output voltage V_{OUT}. However, in some arrangements, V_{AVP} may be scaled and used to compensate a scaled or non-scaled version of the output voltage.

In power supply control loop 88 presented in FIG. 5, the offset voltage V_{AVP} is directly applied to the output voltage V_{OUT} for compensation. However, in other arrangements, the offset voltage may be buffered, amplified, or further processed (e.g., filtered) prior to applying to the output voltage. Furthermore, the offset voltage may be applied to a buffered version of the output voltage.

Power supply regulator 74 presented in FIG. 6 implements AVP in a single-phase DC-DC converter. In other implementations, the AVP technique may be included in a multiple-phase circuit (e.g., three-phase DC-DC converter). Additionally, besides implementing the AVP technique with analog circuitry, digital circuitry, or a combination of analog and digital circuitry, may be used to implement AVP that uses inductor ripple current to provide an accurate and controllable output voltage.

A number of implementations have been described. Nevertheless, it will be understood that various modifications may be made. Accordingly, other implementations are within the scope of the following claims.

What is claimed is:

1. A method of regulating a power supply, comprising the steps of:
measuring an inductor ripple current within the power supply; and
producing an active voltage positioning offset voltage for compensating an output voltage, wherein the active voltage positioning offset voltage is based in part on the measured inductor ripple current.

2. The method of claim 1, further comprising the steps of:
adjusting the output voltage in accordance with the active voltage positioning offset voltage.

3. The method of claim 1, further comprising the steps of:
adjusting the output voltage in accordance with the sum of the active voltage positioning offset voltage and the output voltage.

4. The method of claim 1, wherein measuring an inductor ripple current includes measuring current propagating in an inductor current sense resistor.

5. The method of claim 2, wherein adjusting the output voltage includes applying the active voltage positioning offset voltage to the output voltage.

6. The method of claim 1, wherein the active voltage positioning offset voltage is based in part on multiplying a gain factor and the measured inductor ripple current.

7. The method of claim 6, wherein the gain factor is based in part on a ratio of resistance values.

8. The method of claim 3, wherein adjusting the output voltage in accordance with the sum of the active voltage positioning offset voltage and the output voltage includes substantially holding the sum of the active voltage positioning offset voltage and the output voltage to a constant value.

9. The method of claim 1, wherein the measured inductor ripple current is numerically scaled.

10. The method of claim 3, wherein the sum of the active voltage positioning offset voltage and the output voltage includes a buffered version of the output voltage.

11. The method of claim 1, wherein producing the active voltage positioning offset voltage includes averaging the inductor ripple current.

12. A system for regulating a power supply, comprising:
a current sensor for measuring an inductor ripple current within the power supply; and
a voltage source for producing an active voltage positioning offset voltage for compensating an output voltage, wherein the active voltage positioning offset voltage is based in part on the measured inductor ripple current.

13. The system of claim 12, wherein the current sensor includes an inductor current sense resistor.

14. The system of claim 12, wherein the sum of active voltage positioning offset voltage and the output voltage regulate the output voltage.

15. The system of claim 12, wherein the active positioning offset voltage is based in part on multiplying a gain factor and the inductor ripple current.

16. The system of claim 15, further comprising:
at least two resistors of resistance values adapted for setting the gain factor.

17. The system of claim 16, wherein the gain factor is based in part on a ratio of the two resistor resistance values.

18. The system of claim 14, further comprising:
circuitry for substantially holding the sum of the active positioning offset voltage and the output voltage to a constant value.

19. The system of claim 12, wherein the measured inductor ripple current is numerically scaled.

20. The system of claim 14, wherein the sum of the active voltage positioning offset voltage and the output voltage level includes a buffered version of the output voltage.

21. The system of claim 12, wherein producing the active voltage positioning offset voltage includes averaging the inductor ripple current.

22. A system of regulating a power supply, comprising:
means for an measuring inductor ripple current within the power supply; and
means for producing an active voltage positioning offset voltage for compensating an output voltage, wherein the active voltage positioning offset voltage is based in part on the measured inductor ripple current.

23. The system of claim 22, further comprising:
means for adjusting the output voltage in accordance with the active voltage positioning offset voltage.

24. The system of claim 22, further comprising:
means for adjusting the output voltage in accordance with the sum of the active voltage positioning offset voltage and the output voltage.

25. The system of claim 22, wherein means for measuring the inductor ripple current includes means for measuring current propagating in an inductor current sense resistor.

26. The system of claim 23, wherein means for adjusting the output voltage includes means for applying the active voltage positioning offset voltage to the output voltage.

27. The system of claim 22, wherein the active voltage positioning offset voltage is based in part on multiplying a gain factor and the measured inductor ripple current.

28. The system of claim 27, wherein the gain factor is based in part on a ratio of resistance values.

29. The system of claim 24, wherein means for adjusting the output voltage in accordance with the sum of the active voltage positioning offset voltage and the output voltage includes means for substantially holding the sum of the active voltage positioning offset voltage and the output voltage to a constant value.

30. The system of claim 22, wherein the measured inductor ripple current is numerically scaled.

31. The system of claim 24, wherein the sum of the active voltage positioning offset voltage and the output voltage includes a buffered version of the output voltage.

32. The system of claim 22, wherein producing the active voltage positioning offset voltage includes averaging the inductor ripple current.

33. A voltage regulator for regulating a power supply, comprising:
an inductor current sense resistor for sensing an inductor ripple current;
a voltage amplifier for receiving a measure of a voltage drop across the inductor current sense resistor and for producing an active voltage positioning offset voltage; and
circuitry for substantially holding the sum of the active voltage positioning offset voltage and an output voltage to a constant value.

34. The voltage regulator of claim 33, wherein the circuitry includes circuitry for measuring the difference between the constant value and the sum of the active voltage positioning offset voltage and the output voltage.

35. The voltage regulator of claim 34, wherein the circuitry for measuring the difference includes a high input-impedance, unity-gain differential amplifier.
